(19) United States
(12) Patent Application Publication
(10) Pub. No.: US 2019/0042063 A1
(43) Pub. Date: Feb. 7, 2019

(54) VEHICLE-MOUNTED EQUIPMENT OPERATION SUPPORT SYSTEM

(71) Applicant: Yazaki Corporation, Tokyo (JP)

(72) Inventors: Yoshiyuki MIZUNO, Shizuoka (JP); Takafumi SAITO, Shizuoka (JP); Hideaki MORI, Shizuoka (JP)

(73) Assignee: Yazaki Corporation, Tokyo (JP)

(21) Appl. No.: 16/019,869

(22) Filed: Jun. 27, 2018

(30) Foreign Application Priority Data
Aug. 4, 2017 (JP) 2017-151601

(51) Int. Cl. G06F 3/0482; G06F 3/0481; G06F 3/0488

(52) U.S. Cl. CPC G06F 3/0482; B60R 16/023; G06F 3/0488; G06F 3/04817

(57) ABSTRACT

A vehicle-mounted equipment operating device includes an operation unit allowing an operator to perform an operation with a finger, an operation mode detection unit detecting an operation mode of the operator, a display device, and a control device capable of performing display control of the operation-related information on the display device and shifting a screen from a current level screen to a level screen of a level according to an output signal of the operation mode detection unit, and the control device displays a home screen icon, which is an icon representing an operation mode with respect to the operation unit for a guide to a home screen in a lower level screen and expresses both a house and an arrow by joining an upper side of a rectangle and a base side of a triangle, on the lower level screen as the operation-related information.

### CROSS-REFERENCE TO RELATED APPLICATION(S)

The present application claims priority to and incorporates by reference the entire contents of Japanese Patent Application No. 2017-151601 filed in Japan on Aug. 4, 2017.

### BACKGROUND OF THE INVENTION

### 1. Field of the Invention

The present invention relates to a vehicle-mounted equipment operation support system.

### 2. Description of the Related Art

Conventionally, various types of equipment (hereinafter referred to as “vehicle-mounted equipment”) are mounted on a vehicle, and a vehicle-mounted equipment operation support system which supports an operator operating the vehicle-mounted equipment is provided. The vehicle-mounted equipment operation support system controls the vehicle-mounted equipment in response to an operation of the operator with respect to an operation device (hereinafter referred to as a “vehicle-mounted equipment operating device”) and displays information relating to the operation (hereinafter referred to as “operation-related information”) on a display device. For example, the following Japanese Patent Application Laid-open No. 2012-177999 discloses a technique of changing display content of a display device in accordance with content of an operation of an operator.

Meanwhile, there is a case where vehicle-mounted equipment selection information to select a desired vehicle-mounted equipment from among a plurality of vehicle-mounted equipment and function selection information to select a function of the selected vehicle-mounted equipment, for example, are displayed on the display device as the operation-related information. In this case, the vehicle-mounted equipment selection information is the highest-level information, and the function selection information is information one level below than information of the vehicle-mounted equipment selection information. Accordingly, in the display device, a screen displaying the vehicle-mounted equipment selection information is an initial screen (so-called home screen) as a first-level screen of the highest level, a screen displaying the function selection information is a second-level screen (the screen one level below the home screen). In addition, there is a case where vehicle-mounted equipment group selection information is displayed on the display device as the operation-related information. The vehicle-mounted equipment group selection information is information to select a desired vehicle-mounted equipment group from among a plurality of vehicle-mounted equipment groups classified for each type. When the desired vehicle-mounted equipment group has been selected, the vehicle-mounted equipment selection information to select desired vehicle-mounted equipment from among the plurality of vehicle-mounted equipment belonging to the vehicle-mounted equipment group is displayed on the display device. In this case, the vehicle-mounted equipment group selection information is the highest-level information, the vehicle-mounted equipment selection information is information one level below the vehicle-mounted equipment group selection information, and the function selection information is information one level below than information of the vehicle-mounted equipment selection information.

Accordingly, in the display device, a screen displaying the vehicle-mounted equipment group selection information is an initial screen (home screen) as a first-level screen, the screen displaying the vehicle-mounted equipment selection information is a second-level screen (the screen one level below the home screen), and the screen displaying the function selection information is a third-level screen (the screen two levels below the home screen). In general, in this type of vehicle-mounted equipment operation support system, an arrow icon or character information that indicates an operation mode to return to a screen one level above is displayed on a lower level screen. However, in the vehicle-mounted equipment operation support system, the screens of the display device shift diversely, for example, as the number of vehicle-mounted equipment to be operated increases, and as the functions of the vehicle-mounted equipment are multi-functional. Accordingly, in this case, it may be difficult to distinguish whether the arrow icon or character information points to the higher level to return to the home screen.

### SUMMARY OF THE INVENTION

Thus, a purpose of the present invention is to provide a vehicle-mounted equipment operation support system that is capable of performing an easy guide to a home screen.

According to an aspect of the present invention, a vehicle-mounted equipment operation support system includes an operation unit that allows an operator to perform an operation with a finger when operating or stopping vehicle-mounted equipment mounted on a vehicle and an operation mode detection unit that detects an operation mode of the operator with respect to the operation unit, in which the operation unit is arranged at a position that is closer to a vehicle front side than a steering wheel for enabling the operation of the operator without taking off a hand from the steering wheel, a display device configured to display an operation-related information relating to the operation of the operator with respect to the operation unit, and a control device configured to perform a display control of the operation-related information on the display device based on an output signal of the operation mode detection unit and to shift from a current level screen to a level screen of a level according to the output signal of the operation mode detection unit. The control device displays a home screen icon, which is an icon representing an operation mode with respect to the operation unit for a guide to a home screen which is a highest level screen in a lower level screen and expresses both a house and an arrow by joining an upper side of a rectangle and a base side of a triangle, on the lower level screen as the operation-related information.

According to another aspect of the present invention, in the vehicle-mounted equipment operation support system, the control device may display the home screen icon and character information to associate the home screen icon with the home screen on the home screen as the operation-related information.

According to still another aspect of the present invention, in the vehicle-mounted equipment operation support system, the control device may display the home screen icon above current selection candidate information when a plurality of pieces of selection candidate information that is selectable by the operator with an operation with respect to the operation unit and the current condition selection candidate information that is a currently selected candidate among the plurality of pieces of selection candidate information are displayed on the lower level screen as the operation-related information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view illustrating a vehicle-mounted equipment operation support system according to an embodiment;

FIG. 2 is a top view illustrating the vehicle-mounted equipment operation support system according to the embodiment;

FIG. 3 is a view illustrating an example of a slide operation;

FIG. 4 is a view illustrating an example of a touch operation;

FIG. 5 is a perspective view illustrating a vehicle-mounted equipment operating device according to the embodiment;

FIG. 6 is a cross-sectional view taken along a line X-X of FIG. 5;

FIG. 7 is a view illustrating an example of a home screen;

FIG. 8 is a view illustrating an example of a lower level screen; and

FIG. 9 is a front view illustrating a vehicle-mounted equipment operation support system according to a modification.

### DETAILED DESCRIPTION OF THE PREFERRED EMBODIMENTS

Hereinafter, an embodiment of a vehicle-mounted equipment operation support system according to the present invention will be described in detail with reference to the drawings. Incidentally, the invention is not limited by the embodiment.

### Embodiment

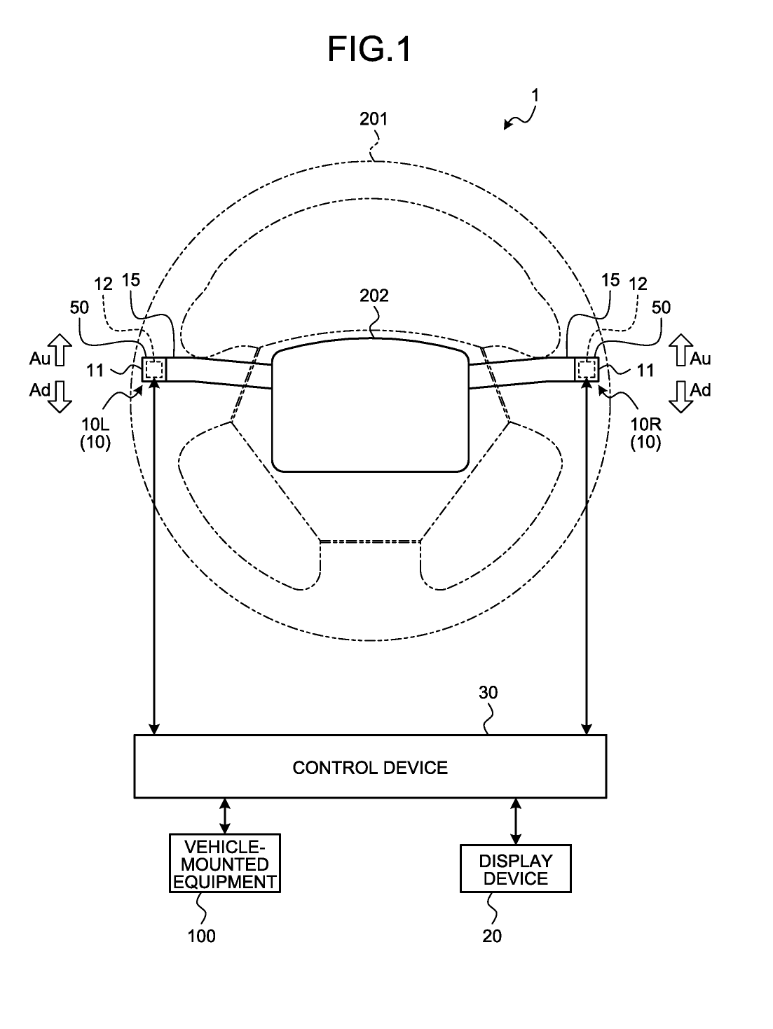

One of embodiments of the vehicle-mounted equipment operation support system according to the present invention will be described with reference to FIGS. 1 to 9.

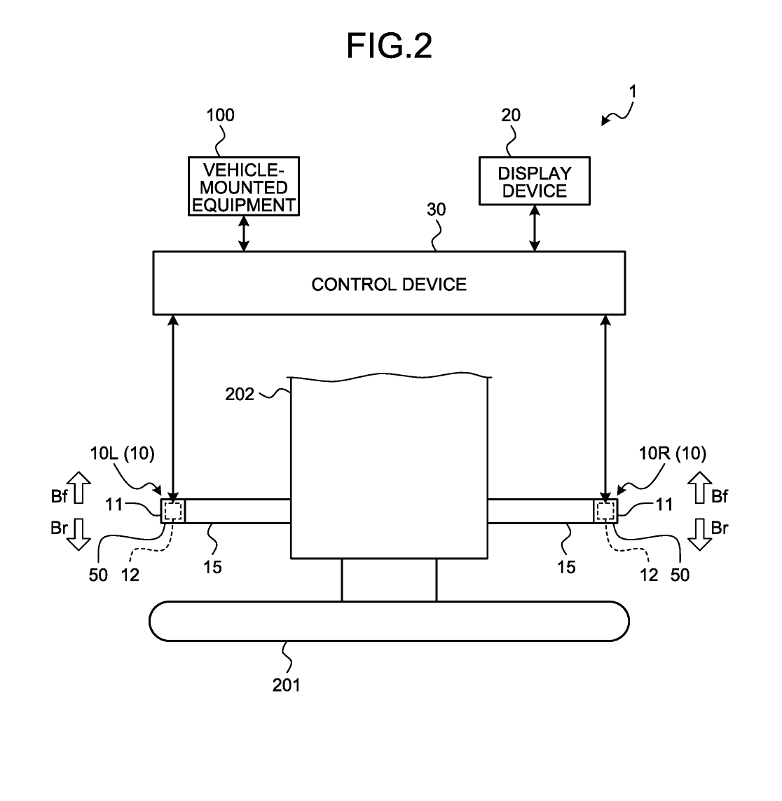

Reference sign 1 in FIGS. 1 and 2 represents the vehicle-mounted equipment operation support system according to the present embodiment. A vehicle-mounted equipment operation support system 1 receives an operation of an operator (such as a driver of a vehicle) and operates or stops equipment (vehicle-mounted equipment) 100 mounted on the vehicle. In addition, when the operator performs the operation with respect to the vehicle-mounted equipment 100, the vehicle-mounted equipment operation support system 1 also supports the operator operating the vehicle-mounted equipment 100 by presenting information (operation-related information) relating to the operation in at least a visible manner.

The vehicle-mounted equipment operation support system 1 according to the present embodiment is provided with: an operation device (vehicle-mounted equipment operating device) 10 configured to operate the vehicle-mounted equipment 100; a display device 20 capable of displaying the operation-related information; and a control device 30 capable of performing control of the vehicle-mounted equipment 100 and display control of the operation-related information onto the display device 20.

The vehicle-mounted equipment operating device 10 is allowing the operator to perform an operation with a finger when operating or stopping the vehicle-mounted equipment 100. The vehicle-mounted equipment operating device 10 is provided with at least one operation unit 11 operated by the operator's finger and an operation mode detection unit 12 which detects an operation mode of the operator with respect to the operation unit 11. The operation unit 11 may be a dedicated operating member for allowing the operator to operate, or may be assigned to a part of a member having a function different from the operation of the operator. The operation mode detection unit 12 is a detector (an encoder, a sensor, or the like), a switch, or the like that detects the operation mode of the operator with respect to the operation unit 11. The control device 30 executes control of the operation and stop of the vehicle-mounted equipment 100 based on the output signal of the operation mode detection unit 12. In addition, the control device 30 displays the operation-related information on the display device 20 based on the output signal.

In the vehicle-mounted equipment operating device 10, the operation unit 11 is arranged at a position where the operator can operate the operation unit 11 inside a vehicle compartment. In this illustrated example, the operation unit 11 is arranged at a position that is closer to a vehicle front side than the steering wheel 201 (that is, a back side of a steering wheel 201) and enables the operator to perform the operation thereof without taking off a hand from the steering wheel 201. The position is a place where the operator can reach with a fingertip of the finger (for example, a middle finger or an index finger) while holding the steering wheel 201. This position may be any place as long as the position is in the vicinity of a rim of the steering wheel 201, but it is desirable to provide this position in the vicinity of a position at which the steering wheel 201 is held by a general operator. For example, the operation unit 11 of the vehicle-mounted equipment operating device 10 is arranged on at least one of a left side (vehicle left side) and a right side (vehicle right side) in a vehicle width direction when viewed from a center portion of the steering wheel 201. In the illustrated examples of FIGS. 1 and 2, the same vehicle-mounted equipment operating devices 10 are provided on the vehicle left side and the vehicle right side, one by one (vehicle-mounted equipment operating devices 10L and 10R). The operation unit 11 is arranged at a position spaced apart from a left end portion of the steering wheel 201 in the vehicle width direction within a range where a fingertip of a left hand reaches a vehicle front side in the case of the vehicle-mounted equipment operating device 10L on the vehicle left side. In the same manner, the operation unit 11 is arranged at a position spaced apart from a right end portion of the steering wheel 201 in the vehicle width direction within a range where a fingertip of a right hand reaches a vehicle front side in the case of the vehicle-mounted equipment operating device 10R on the vehicle right side. Each of the vehicle-mounted equipment operating devices 10L and 10R is configured to be symmetric right and left as viewed from the center portion of the steering wheel 201. Thus, the vehicle-mounted equipment operating device 10 will be described hereinafter by exemplifying the vehicle-mounted equipment operating device 10R on the vehicle right side as a representative as necessary.

Here, the vehicle-mounted equipment 100 refers to equipment that is mounted at any place in the vehicle regardless of inside or outside of a vehicle compartment, and has at least one function of operating according to the operation of the operator on the operation unit 11 of the vehicle-mounted equipment operating device 10. The vehicle-mounted equipment 100 operates or stops the function (including a change of an operation state) in accordance with an operation command accompanying the operation of the operator. For example, the vehicle-mounted equipment 100 inside the vehicle compartment includes acoustic equipment such as audios and radios, an air conditioning machine (so-called air conditioner), a car navigation system, and the like. In addition, the vehicle-mounted equipment 100 inside the vehicle compartment also includes equipment that is not attached to the vehicle in advance but is mounted on the vehicle as being carried inside the vehicle compartment (for example, communication equipment such as a mobile phone, a portable music player, and the like). On the other hand, the vehicle-mounted equipment 100 outside the vehicle compartment includes vehicle lighting equipment (a headlamp, a taillight, and the like), a direction indicator, a wiper, and the like. The control device 30 may be one that can control the operation and stop of the vehicle-mounted equipment 100.

The operation-related information is information that relates to the operation of the operator on the operation unit 11 of the vehicle-mounted equipment operating device 10. It is possible to consider information that serves as assistance when the operator operates the operation unit 11 of the vehicle-mounted equipment operating device 10 (hereinafter, referred to as “operation assistance information”), information indicating an operation result in a case where the operator operates the operation unit 11 of the vehicle-mounted equipment operating device 10 (hereinafter, referred to as “operation result information”), and information indicating a state of the vehicle-mounted equipment 100 (hereinafter, referred to as “equipment information”), and the like, as the operation-related information. For example, the control device 30 causes at least one of the operation assistance information, the operation result information, and the equipment information to be displayed on the display device 20 as the operation-related information.

For example, a plurality of pieces of selection candidate information selectable by the operator through an operation on the operation unit 11 corresponds to the operation assistance information. In this case, the plurality of pieces of selection candidate information and information indicating the operation mode with respect to the operation unit 11 at the time of selecting a desired information from among the plurality of pieces of selection candidate information are displayed on the display device 20 as the operation assistance information.

Specifically, the selection candidate information is information to select an object to be operated from among a plurality of the vehicle-mounted equipment 100 and vehicle-mounted equipment groups (obtained by collectively classifying the same type of vehicle-mounted equipment 100). For example, the selection candidate information is selection icons individually representing the plurality of vehicle-mounted equipment 100 and the vehicle-mounted equipment groups. In addition, the selection candidate information is information to select a desired function from among a plurality of functions of the vehicle-mounted equipment 100, and information to select a desired condition from among a plurality of selection conditions assigned to the functions of the vehicle-mounted equipment 100. For example, when the vehicle-mounted equipment 100 is audio equipment, a selection icon for each function configured to select a desired function from among functions of music selection and volume adjustment, numerical information for each level of volume serving as a selection condition in the volume adjustment function, and the like are used as the selection candidate information.

Current status selection candidate information which is a currently selected candidate among the plurality of pieces of selection candidate information, selection confirmation information which has been confirmed the current selection candidate information as a selection target, and the like correspond to the operation result information. In this case, the current selection candidate information and the selection confirmation information are displayed on the display device 20 as the operation result information. For example, the current selection candidate information and the selection confirmation information are displayed using icons or character information.

The equipment information may include not only information on an operation state or a stop state of the vehicle-mounted equipment 100 in a case where the operation unit 11 of the vehicle-mounted equipment operating device 10 is operated but also information on an operation state or a stop state of the vehicle-mounted equipment 100 when the operation unit 11 is not operated. For example, in a case where the vehicle-mounted equipment 100 is the audio equipment, information representing the volume after the volume adjustment is conceivable as the equipment information.

Incidentally, the operation-related information may be not only information that stimulates a visual sense of the operator as above but also information that stimulates an auditory sense of the operator such as a sound and voice.

A specific example of the vehicle-mounted equipment operating device 10 will be described hereinafter.

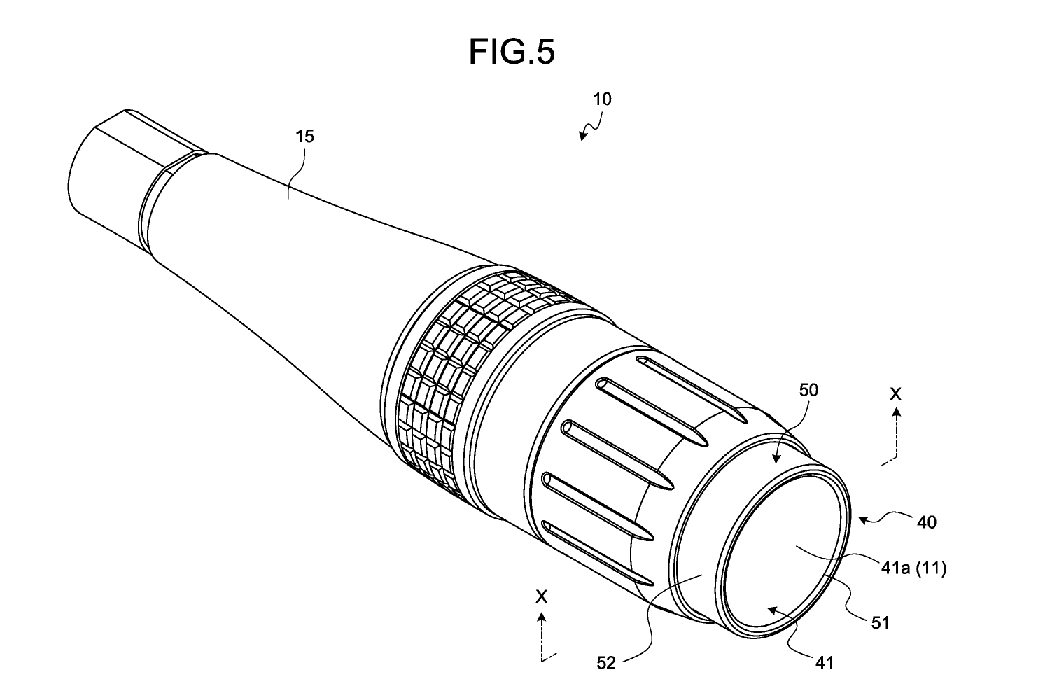

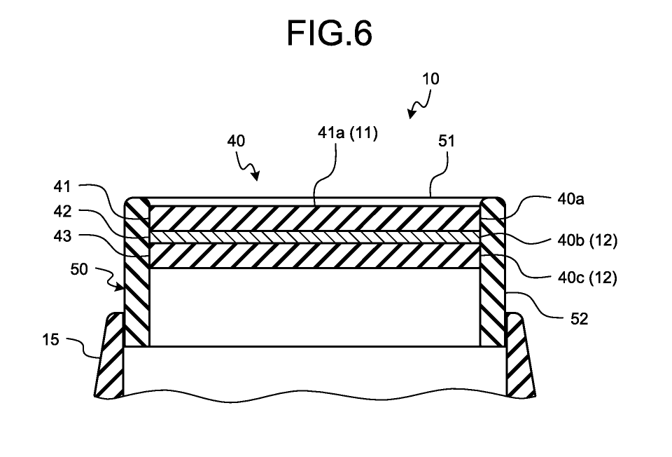

The vehicle-mounted equipment operating device 10 of the present embodiment includes an operation input detector 40 provided with an operation unit 11 and an operation mode detection unit 12 (FIGS. 5 and 6).

The operation input detector 40 is provided with at least one contact operating surface 41a, which is a part allowing the operator to perform a contact operation with a finger and to which a contact operation mode is assigned, as the operation unit 11 (FIGS. 5 and 6). At least one contact operation mode is assigned to the contact operating surface 41a. For example, when the plurality of contact operating surfaces 41a are provided, one or a plurality of contact operation modes are assigned to each of the contact operating surfaces 41a. When the single contact operating surface 41a is provided, a plurality of contact operation modes are assigned to the contact operating surface 41a. Here, a plurality of contact operation modes are allocated to the single contact operating surface 41a. On the contact operating surface 41a illustrated in this example, a slide operation of tracing the contact operating surface 41a with a fingertip and a touch operation to touch the contact operating surface 41a with the fingertip are assigned as the contact operation modes.

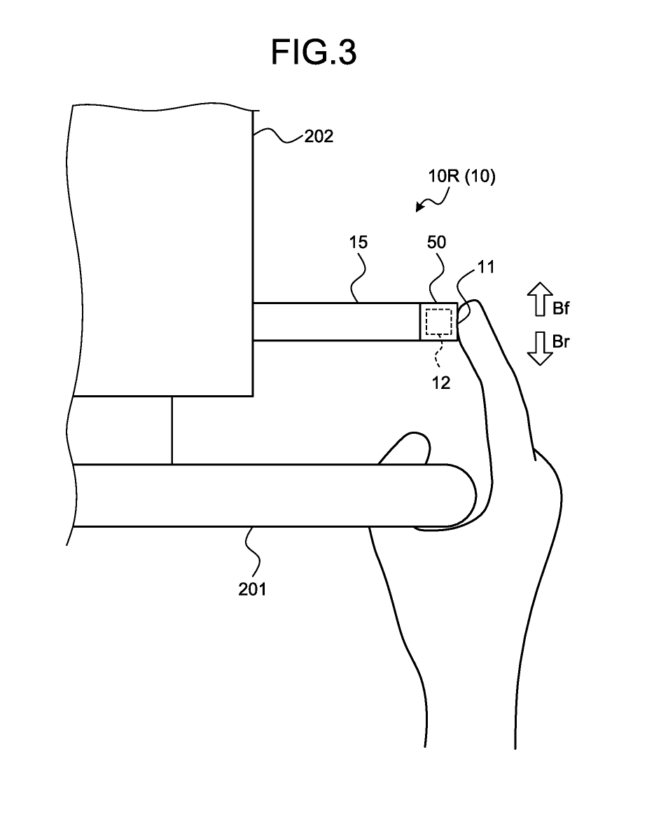

Slide operations in a plurality of directions can be performed in the contact operating surface 41a. A slide operation to an upper side of the vehicle (an arrow Au in FIG. 1), a slide operation to a lower side of the vehicle (an arrow Ad in FIG. 1), a slide operation to the front of the vehicle (an arrow Bf in FIGS. 2 and 3), and a slide operation to the rear of the vehicle (an arrow Br in FIGS. 2 and 3) are set on the contact operating surface 41a illustrated in this example. For example, it is possible to assign a selection operation function (that is, information relating to the operation of the vehicle-mounted equipment 100), such as a device selection operation to select desired equipment from among the plurality of vehicle-mounted equipment 100 and the vehicle-mounted equipment groups, a function selection operation to select a desired function from among a plurality of functions of the vehicle-mounted equipment 100, and a condition selection operation to select a desired selection condition from among a plurality of selection conditions of a certain function, as the slide operation. The device selection operation and the function selection operation can be referred to as a so-called menu selection operation. The function selection operation is an operation of selecting a desired function from among a media selection function, a volume selection function, a track selection function, and the like, for example, in a case where the vehicle-mounted equipment 100 is the acoustic equipment. The condition selection operation is an operation of selecting a desired volume, for example, when the volume selection function is selected.

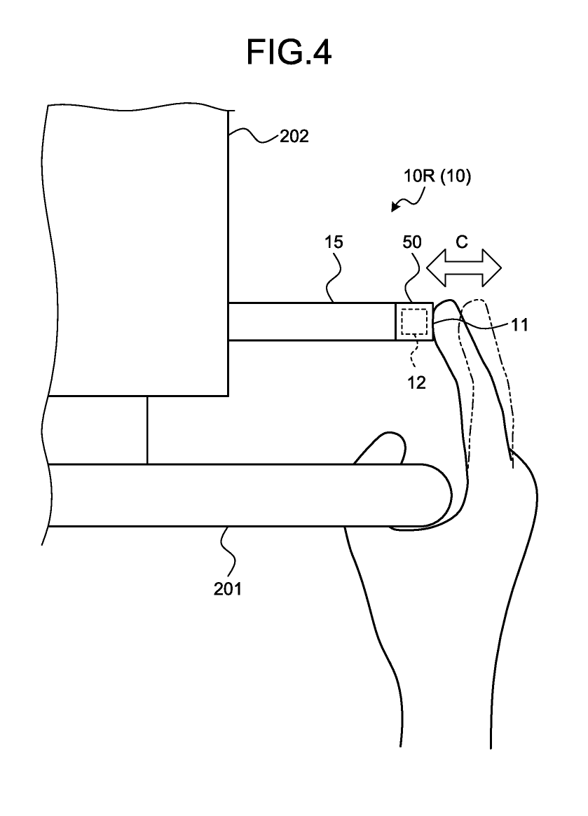

The touch operation is an operation of touching the contact operating surface 41a with a finger by reciprocating the finger in the direction of an arrow C in FIG. 4. For example, it is possible to assign a decision operation function performed at the time of deciding a function or a selection condition selected by the slide operation in accordance with contact time, a shift operation function to a higher level screen by one level or a lower level screen by one level, a return operation function to instantly return to a home screen which is the highest level screen, and the like, as the touch operations. It is possible to set a single touch operation or a plurality of times of repeated hitting operations as the touch operation.

The operation input detector 40 illustrated in this example is configured as a capacitive touch sensor, and is accommodated in an accommodating member 50 as a laminate of an insulating layer 40a, a conductive layer 40b, and a substrate layer 40c (FIG. 6). The contact operating surface 41a is provided on the insulating layer 40a. On the other hand, the operation mode detection unit 12 is configured of the conductive layer 40b and the substrate layer 40c.

A mutual capacitance system can be used as the operation input detector 40. Thus, the operation input detector 40 is provided with an insulating contact operating member 41 including the contact operating surface 41a (FIGS. 5 and 6), and the contact operating member 41 forms the insulating layer 40a (FIG. 6). The contact operating member 41 illustrated in this example is molded in a disk shape using an insulating material such as glass and synthetic resin. One of the two circular flat surfaces is used as the contact operating surface 41a in the contact operating member 41 (FIGS. 5 and 6). The contact operating surface 41a illustrated in this example is formed to have a size that can be covered with the fingertip of the operator's finger. In addition, the operation input detector 40 is provided with a pattern electrode 42 in which a transmitting electrode and a receiving electrode are alternately arranged in a lattice pattern, and the pattern electrode 42 forms the conductive layer 40b (FIG. 6). In addition, the operation input detector 40 is provided with a substrate 43 including an integrated circuit (not illustrated) for arithmetic processing, and the substrate 43 forms the substrate layer 40c (FIG. 6). The integrated circuit is electrically connected to the pattern electrode 42 and detects a change of an electric field between the transmitting electrode and the receiving electrode. The integrated circuit transmits the detection result (that is, the change of the electric field indicating the contact operation mode) to the control device 30 in a wired or wireless manner.

The vehicle-mounted equipment operating device 10 of the present embodiment is provided with the accommodating member 50 that accommodates and holds the operation input detector 40 (FIGS. 1 to 6). The accommodating member 50 has a cylindrical peripheral wall portion 52 forming a circular opening 51 (FIGS. 5 and 6). The accommodating member 50 is molded using an insulating material such as synthetic resin. In this illustrated example, the operation input detector 40 is accommodated so as to expose the contact operating surface 41a from the opening 51.

The vehicle-mounted equipment operating device 10 illustrated in this example is provided with a longitudinal member 15 that protrudes and extends from at least one of a left end and a right end of a steering column 202 in the vehicle width direction (FIGS. 1 to 6). Here, the longitudinal member 15 is provided for each of the left and right vehicle-mounted equipment operating devices 10L and 10R. The longitudinal member 15 is a member that connects the operation unit 11 provided as the contact operating surface 41a and the steering column 202, and the operation unit 11 is provided at a distal end in a protruding direction of the longitudinal member 15. The longitudinal member 15 may be molded in a straight shape or provided with a bent portion in the middle of a path as long as the longitudinal member 15 extends between the operation unit 11 and the steering column 202. The longitudinal member 15 is formed in, for example, a cylindrical shape, and the accommodating member 50 is fitted and fixed into an internal space at the distal end thereof, thereby arranging the operation unit 11 at the distal end.

In the vehicle-mounted equipment operating device 10, an output signal according to the contact operation mode with respect to the contact operating surface 41a is output from the operation mode detection unit 12 and is input to the control device 30. The control device 30 detects the contact operation mode with respect to the contact operating surface 41a based on the output signal. For example, when detecting the slide operation and the slide operation direction thereof, the control device 30 executes control in response to the slide operation. In addition, when detecting the touch operation together with the time touching the contact operating surface 41a, the control device 30 executes control according to the touch operation.

For example, when the slide operation or the touch operation has been performed on the contact operating surface 41a, the control device 30 can perform display control of the operation-related information onto the display device 20 based on the output signal of the operation mode detection unit 12 accompanying the contact operation. In addition, when the touch operation is performed on the contact operating surface 41a, the control device 30 can shift a screen from a current level screen to a level screen of a level according to the output signal of the operation mode detection unit 12 accompanying the touch operation.

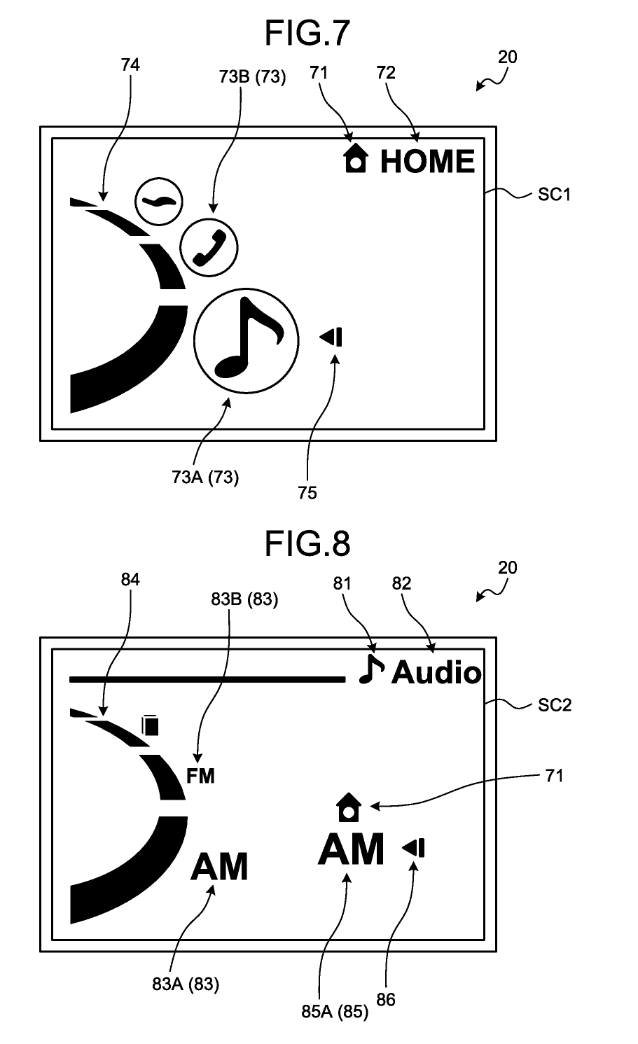

When a home screen SC1 (FIG. 7) is displayed on the display device 20, the control device 30 displays a home screen icon 71 and character information 72 for associating the home screen icon 71 with the home screen SC1 as a first layer screen on the home screen SC1 as the operation-related information.

The home screen icon 71 is an icon configured to indicate that the current level screen (that is, the level screen being displayed on the display device 20) is the home screen SC1. The home screen icon 71 makes the operator recognize that the current level screen is the home screen SC1 by displaying the home screen icon 71 at a predetermined position on the home screen SC1. Here, the home screen icon 71 is arranged at one of four corners of the rectangular home screen SC1.

The character information 72 is displayed to form a pair with the home screen icon 71 to clearly indicate that the current level screen is the home screen SC1. Here, a word “HOME” is displayed as the character information 72. The character information 72 is adjacent to the home screen icon 71.

On the home screen SC1 illustrated in this example, a selection icon 73 for each of the plurality of vehicle-mounted equipment 100 and vehicle-mounted equipment groups and a selection operation mode icon 74 representing an operation mode when selecting a desired selection icon from among the plurality of selection icons 73, and a decision operation mode icon 75 representing an operation mode when making decision with the selected selection icon 73 are displayed as the operation-related information.

The selection icon 73 is the selection candidate information described above. Here, an audio equipment group icon 73A, a telephone icon 73B, and the like are displayed as the selection icons 73. In addition, here, the selection operation mode icon 74 imitating a slide operation direction in the arrows Bf and Br (FIG. 3) with respect to the contact operating surface 41a and the decision operation mode icon 75 imitating the touch operation in the arrow C (FIG. 4) with respect to the contact operating surface 41a are displayed. The selection operation mode icon 74 and the decision operation mode icon 75 correspond to the contact operating surface 41a of the vehicle-mounted equipment operating device 10R on the right side of the vehicle. Therefore, the selection operation mode icon 74 has an arc shape projecting toward the right side of the vehicle. In addition, the decision operation mode icon 75 is a triangular mark whose vertex is the left side of the vehicle so as to make decision with the touch operation from the right side of the vehicle to the left side of the vehicle, and is adjacent to the right side of the vehicle of the audio equipment group icon 73A.

FIG. 8 illustrates a lower level screen (a second level screen SC2). The second level screen SC2 is a screen obtained by shift of the control device 30 from the home screen SC1 when the operator who has viewed the home screen SC1 selects the audio equipment group icon 73A by the slide operation and the operator decides the shift to the lower level screen in the audio equipment group by the touch operation.

On the second level screen SC2, a level icon 81 indicating what the current level is and character information 82 are displayed as the operation-related information. Here, the level icon 81 representing the audio equipment group is displayed, and a word “Audio” indicating the audio equipment group is displayed as character information 82 to be adjacent to the level icon 81. The level icon 81 and the character information 82 are displayed as if being replaced with the home screen icon 71 and the character information 72.

In addition, on the second level screen SC2, a plurality of selection icons 83 for each audio equipment, a selection operation mode icon 84 representing an operation mode when selecting a desired selection icon from among the plurality of selection icons 83, a current selection candidate icon 85 indicating an icon which is a currently selected candidate among the plurality of selection icons 83, and a decision operation mode icon 86 representing an operation mode when making decision with the current selection candidate icon 85 are displayed as the operation-related information.

The selection icon 83 is the selection candidate information described above. Here, an AM radio icon 83A, an FM radio icon 83B, and the like are displayed as the selection icons 83. In addition, the selection operation mode icon 84 is equivalent to the selection operation mode icon 74 of the home screen SC1. In addition, the current selection candidate icon 85 is the current selection candidate information described above. Here, an AM radio icon 85A is displayed as the current selection candidate icon 85. In addition, the decision operation mode icon 86 is equivalent to the decision operation mode icon 75 of the home screen SC1. The decision operation mode icon 86 is adjacent to the right side of the vehicle of the current selection candidate icon 85 (the AM radio icon 85A).

Here, the control device 30 of the present embodiment causes the home screen icon 71 to be displayed not only on the home screen SC1 but also on the lower level screen such as the second level screen SC2 as the operation-related information. The home screen icon 71 in this case is displayed as one representing the operation mode with respect to the operation unit 11 for a guide to the home screen SC1 on the lower level screen. That is, the home screen icon 71 indicates that a current level screen is the home screen SC1 on the home screen SC1, and indicates the operation mode for a guide to the home screen SC1 of the higher level on the lower level screen. The home screen icon 71 is a mark expressing both a house and an arrow by joining an upper side of a rectangle and a base side of a triangle so as to contain two pieces of different types of information on the home screen SC1 and the lower level screen.

As described above, since the home screen icon 71 of the present embodiment has the shape of the house (that is, the home), it is possible to make the operator reminiscent of the relation with the home screen SC1. Further, since this home screen icon 71 has not only the shape of the house but also the arrow shape with the vertex side of the triangle as the destination, it is possible to make the operator reminiscent of the slide operation direction with respect to the contact operating surface 41a toward the vertex side. In this manner, with the vehicle-mounted equipment operation support system 1 of the present embodiment, the operator can easily understand how to manipulate the operation unit 11 (the contact operating surface 41a) on the lower level screen to return to the home screen SC1. That is, this vehicle-mounted equipment operation support system 1 is easy for the operator to remember the operation for returning to the home screen SC1 and to get used to the operation. Therefore, the vehicle-mounted equipment operation support system 1 of the present embodiment can perform an easy guide from the lower level screen to the home screen SC1.

In addition, the vehicle-mounted equipment operation support system 1 of the present embodiment also displays the home screen icon 71 on the home screen SC1, and thus, makes the operator which has viewed the home screen icon 71 on the lower level screen more easily understand the relation with the home screen SC1. Accordingly, the vehicle-mounted equipment operation support system 1 is easier for the operator to remember the operation for returning to the home screen SC1 and to get used to the operation, so that it is possible to perform an easier guide from the lower level screen to the home screen SC1.

In addition, when the plurality of pieces of selection candidate information and the current selection candidate information described above are displayed on the lower level screen as the operation-related information, the control device 30 of the present embodiment displays the home screen icon 71 above the current selection candidate information. For example, the home screen icon 71 is displayed above the current selection candidate icon 85 (the AM radio icon 85A) on the second level screen SC2. Accordingly, in the second level screen SC2, it is easy to make the operator reminiscent of and easily understand returning to the higher level screen (here, the home screen SC1) by performing the slide operation toward the upper side of the vehicle (the arrow Au in FIG. 1) with respect to the contact operating surface 41a of the vehicle-mounted equipment operating device 10R. Therefore, also in this point, the vehicle-mounted equipment operation support system 1 of the present embodiment is easy for the operator to remember the operation for returning to the home screen SC1 and to get used to the operation, so that it is possible to perform an easier guide from the lower level screen to the home screen SC1.

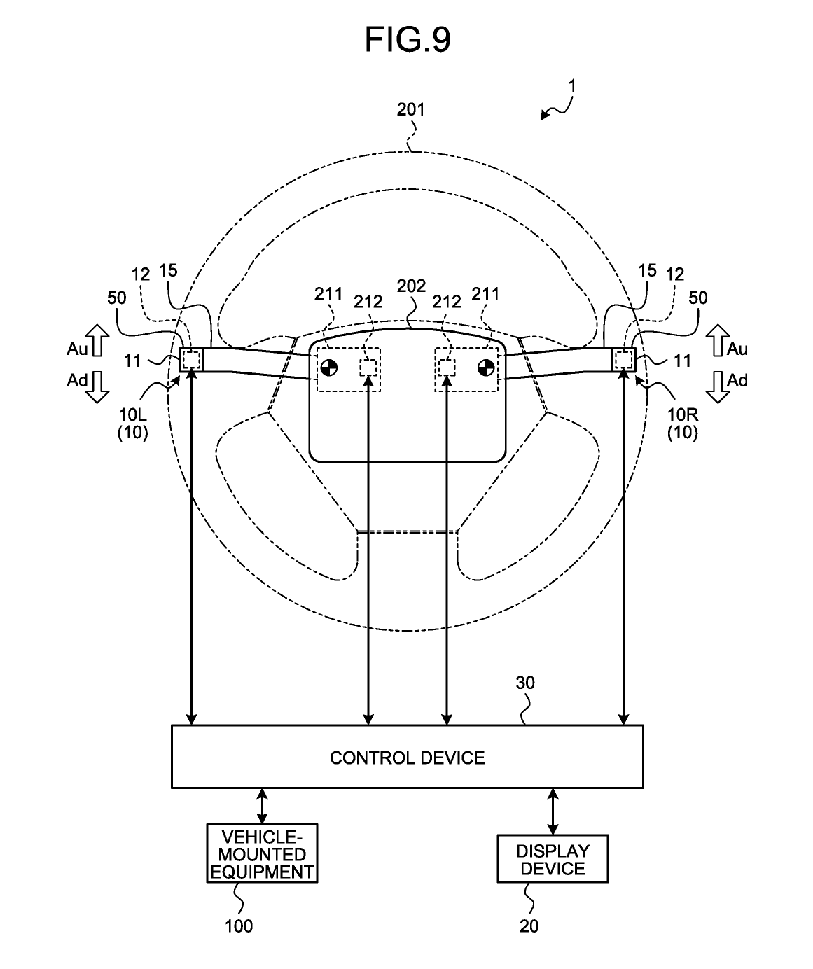

Incidentally, the vehicle-mounted equipment operating device 10 may be provided with the operation unit 11 different from the contact operating surface 41a. For example, the vehicle-mounted equipment operation support system 1 illustrated in FIG. 9 is provided with the above-described longitudinal member 15 as an operation lever, and even in this case, it is possible to obtain the same effect as the above example. The operation lever is capable of tilting with an end on a side of the steering column 202 as a fulcrum, and is used to operate the vehicle-mounted equipment 100. For example, a winker lever or the like is known as this operation lever. The longitudinal member 15 is supported by a support portion 211, which is fixed inside the steering column 202, to be freely tilted. The support portion 211 is configured so as to be freely tilted with an end portion of the longitudinal member 15 on the steering column 202 side as a fulcrum. The longitudinal member 15 illustrated in this example can perform tilting motion toward an upper side of the vehicle (an arrow Au in FIG. 9), tilting motion toward a lower side of the vehicle (an arrow Ad in FIG. 9), tilting motion toward the front of the vehicle (the arrow Bf in FIGS. 2 and 3), and tilting motion toward the rear of the vehicle (the arrow Br in FIGS. 2 and 3) with a neutral position as a base point. At least one of the vehicle-mounted equipment 100 and at least one function of the vehicle-mounted equipment 100 are assigned in each operation direction of the longitudinal member 15.

Here, the support portion 211 may be configured such that the longitudinal member 15 returns to the neutral position by a spring force or the like after being tilted to a certain operation direction from the neutral position or may be configured such that the longitudinal member 15 is manually operated to return to the neutral position by the operator after the longitudinal member 15 is tilted from the neutral position to a certain operation direction. In the latter case, the support portion 211 is configured such that at least one step of tilting motion of the longitudinal member 15 can be performed. In the longitudinal member 15 in this case, a distal end part in its protruding direction serves as the operation unit 11 for the tilting motion.

The vehicle-mounted equipment operating device 10 in this case is provided with a lever operation detection unit 212, which detects a tilting direction of the tilting motion of the longitudinal member 15, as the operation mode detection unit 12 (FIG. 9). The lever operation detection unit 212 transmits an output signal according to the tilting direction of the longitudinal member 15 to the control device 30. The control device 30 can detect the operation direction of the longitudinal member 15 performed by the operator based on the output signal. The control device 30 executes control of the vehicle-mounted equipment 100 according to the operation direction.

Since a home screen icon to be displayed on a lower level screen in the vehicle-mounted equipment operation support system according to the present embodiment has a shape of a house (that is, home) so that it is possible to make the operator reminiscent of a relation with the home screen. Further, this home screen icon has not only the shape of the house but also an arrow shape with a vertex side of a triangle as its destination, and thus, it is possible to make the operator reminiscent of an operation direction with respect to an operation unit toward the vertex side. In this manner, with the vehicle-mounted equipment operation support system according to the present invention, the operator can easily understand how to manipulate the operation unit on the lower level screen to return to the home screen. That is, this vehicle-mounted equipment operation support system is easy for the operator to remember the operation for returning to the home screen and to get used to the operation. Therefore, the vehicle-mounted equipment operation support system according to the present invention can perform an easy guide from the lower level screen to the home screen.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle-mounted equipment operation support system comprising:
a vehicle-mounted equipment operating device including an operation unit that allows an operator to perform an operation with a finger when operating or stopping vehicle-mounted equipment mounted on a vehicle and an operation mode detection unit that detects an operation mode of the operator with respect to the operation unit, in which the operation unit is arranged at a position that is closer to a vehicle front side than a steering wheel for enabling the operation of the operator without taking off a hand from the steering wheel;
a display device configured to display an operation-related information relating to the operation of the operator with respect to the operation unit; and
a controller configured to perform a display control of the operation-related information on the display device based on an output signal of the operation mode detection unit and to shift from a current level screen to a level screen of a level according to the output signal of the operation mode detection unit, wherein
the controller displays a home screen icon, which is an icon representing an operation mode with respect to the operation unit for a guide to a home screen which is a highest level screen in a lower level screen and expresses both a house and an arrow by joining an upper side of a rectangle and a base side of a triangle, on the lower level screen as the operation-related information.

2. The vehicle-mounted equipment operation support system according to claim 1, wherein
the controller displays the home screen icon and character information to associate the home screen icon with the home screen on the home screen as the operation-related information.

3. The vehicle-mounted equipment operation support system according to claim 1, wherein
the controller displays the home screen icon above current selection candidate information when a plurality of pieces of selection candidate information that is selectable by the operator with an operation with respect to the operation unit and the current condition selection candidate information that is a currently selected candidate among the plurality of pieces of selection candidate information are displayed on the lower level screen as the operation-related information.

4. The vehicle-mounted equipment operation support system according to claim 2, wherein
the controller displays the home screen icon above current selection candidate information when a plurality of pieces of selection candidate information that is selectable by the operator with an operation with respect to the operation unit and the current condition selection candidate information that is a currently selected candidate among the plurality of pieces of selection candidate information are displayed on the lower level screen as the operation-related information.
